(19) United States
(12) Patent Application Publication
(10) Pub. No.: US 2014/0152991 A1
(43) Pub. Date: Jun. 5, 2014

(54) Level Sensor of Exposure Apparatus and Wafer-Leveling Methods Using the Same

(71) Applicant: Samsung Electronics Co., Ltd., Gyeonggi-do (KR)

(72) Inventors: Jinseok Heo, Gyeonggi-do (KR); Jeongho Yeo, Gyeonggi-do (KR)

(73) Assignee: Samsung Electronics Co., Ltd., Gyeonggi-do (KR)

(21) Appl. No.: 13/901,652

(22) Filed: May 24, 2013

(30) Foreign Application Priority Data
Jul. 24, 2012 (KR) 1020120080626

(51) Int. Cl. G01N 21/95; G01N 21/55

(52) U.S. Cl. CPC G01N 21/9501; G01N 21/55
USPC 356/445

(57) ABSTRACT

A level sensor of an exposure apparatus includes a light source that generates light that is illuminated onto a top surface of a wafer, a projection part provided in a path of incident light propagating from the light source to the wafer and having a single first slit, a detection part provided in a path of light reflected from the wafer and having a single second slit, and a detector that detects the reflected light that is incident on the second slit of the detection part.

### CROSS-REFERENCE TO RELATED APPLICATIONS

This U.S. non-provisional patent application claims priority under 35 U.S.C. §119 to Korean Patent Application No. 10-2012-0080626, filed on Jul. 24, 2012, in the Korean Intellectual Property Office, the entire contents of which are hereby incorporated by reference.

### BACKGROUND OF THE INVENTION

Example embodiments of the inventive concept relate to a level sensor of an exposure apparatus and a wafer-leveling method using the same.

In general, the formation of semiconductor devices may include a deposition process, an ion implantation process, a photolithography process, an etching process, a cleaning process, and a polishing process, and so forth. For example, by repeatedly performing these processes, a plurality of semiconductor devices may be integrated on a wafer.

The photolithography process may include a step of removing selectively a portion of a layer coated on a wafer to form fine patterns. For example, the photolithography process may include a photoresist coating step of forming a photoresist layer on the entire top surface of the wafer, an exposure step of copying circuit patterns provided on a photomask onto the photoresist layer in a reduction projecting manner, and a developing step of removing selectively and locally a portion of the photoresist layer.

Conventionally, the exposure step may be performed using a stepper with a reduction projection lens. The circuit patterns on the photomask may be optically copied onto the photoresist layer on the wafer through the reduction projection lens.

Preferably, during the exposure step, the reduction projection lens should be aligned in such a way that an optical axis thereof is perpendicular to a top surface of the wafer. However, the optical axis of the reduction projection lens may be microscopically changed by various events (e.g., repetition of the lithography process or steps of checking or maintaining the exposure apparatus). In addition, in the case where the wafer has a spatial variation in terms of a surface flatness, there may be a deviation between the optical axis of the reduction projection lens and a normal line of the top surface of the wafer. The exposure step may further include a leveling process for compensating this deviation.

### SUMMARY

Some embodiments of the inventive concept provide a level sensor of an exposure apparatus that provides an increased accuracy in measuring the level and/or tilt of a wafer.

Other embodiments of the inventive concept provide a wafer leveling method that may provide an increased accuracy in measuring the level and/or tilt of a wafer.

According to some embodiments of the inventive concepts, a level sensor of an exposure apparatus may include a light source that generates light that is illuminated onto a top surface of a wafer, a projection part provided in a path of incident light propagating from the light source to the wafer and having a single first slit, a detection part provided in a path of light reflected from the wafer and having a single second slit, and a detector that detects the reflected light that is incident on the second slit of the detection part.

In some embodiments, the detector may be an imaging device configured to sense the reflected light two-dimensionally. For example, the imaging device may include a charge-coupled device.

In some embodiments, the detector may be configured to sense a change in intensity of the reflected light.

In some embodiments, the light source may include a halogen lamp.

In some embodiments, the first slit may have a width of 4 mm or less and a length of 26 mm or more.

In some embodiments, the second slit has a width and a length that may be equal to or greater than a width and a length of the first slit, respectively.

In some embodiments, the detector may be provided to be in contact with a first surface of the detection part opposite to a second surface onto which the reflected light is incident.

According to some embodiments of the inventive concepts, a method of leveling a wafer may include illuminating an incident light onto a top surface of a wafer, the incident light being propagated through a single first slit of a projection part, passing a reflected light reflected from the top surface of the wafer through a single second slit of a detection part, and detecting the reflected light propagated through the second slit of the detection part.

In some embodiments, the reflected light may be two-dimensionally, for example, using a charge-coupled device as a detector.

In some embodiments, the detector may be configured to sense a change in intensity of the reflected light.

In some embodiments, the detector may be provided to be in contact with a surface of the detection part opposite to a surface, to which the reflected light may be incident.

In some embodiments, the first slit may have a width of 4 mm or less and a length of 26 mm or more.

In some embodiments, the second slit may have a width and a length that are equal to or greater than a width and a length of the first slit, respectively.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a schematic diagram of an exposure apparatus provided with a level sensor according to example embodiments of the inventive concept.

FIGS. 2 and 3 are schematic diagrams illustrating level sensors and wafer-leveling methods using the same, according to example embodiments of the inventive concept.

FIG. 4 is a plan view illustrating a part of a level sensor according to example embodiments of the inventive concept.

FIG. 5 is a plan view illustrating a part of a level sensor according to example embodiments of the inventive concept.

FIG. 6 is a plan view illustrating parts of a level sensor according to example embodiments of the inventive concept.

FIG. 7 illustrates a scanner leveling sensor including nine sensors arranged along a direction of a slit.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of this specification and the relevant art and will not be interpreted in an idealized or overly formal sense unless expressly so defined herein.

Before performing an exposure process on a wafer, a leveling process may be performed for every shot in the wafer, in such a way that a top surface of the wafer is made to be perpendicular to an optical axis of a reduction projection lens.

For each shot, the leveling process may be performed using nine level sensors, which may be arranged linearly, as illustrated in FIG. 7. Further, in the case where a size of shot is fixed, level and tilt of a top surface of the wafer are calculated based on signals obtained from level sensors 10A-10E located within a boundary of the shot (i.e., the exposure area 20), without considering signals obtained from level sensors 10E-10I positioned outside of the boundary of the shot. Accordingly, for a large region (e.g., the entire surface of the wafer), it may be difficult to perform an exact spatial measurement process with the level sensors.

That is, if a shot size is fixed, the level and tilt of the top surface of a wafer are calculated based on signals obtained from the level sensors 10A-10E located within the boundary of the shot. If a full shot has a width of 26 mm, seven sensors may be used for the leveling process, because a region of about 4 mm may be measured by each sensor.

If a large region is represented by one data point, the measurement error may be increased. In particular, in the case where a wafer is formed to have a large height difference from one side to another, there may be a defocusing problem in an exposure process due to the increased measurement error.

Some embodiments of the inventive concepts may overcome these problems by using a single slit and image sensor in the leveling process so that the spatial resolution of the level sensor of an exposure apparatus may be increased.

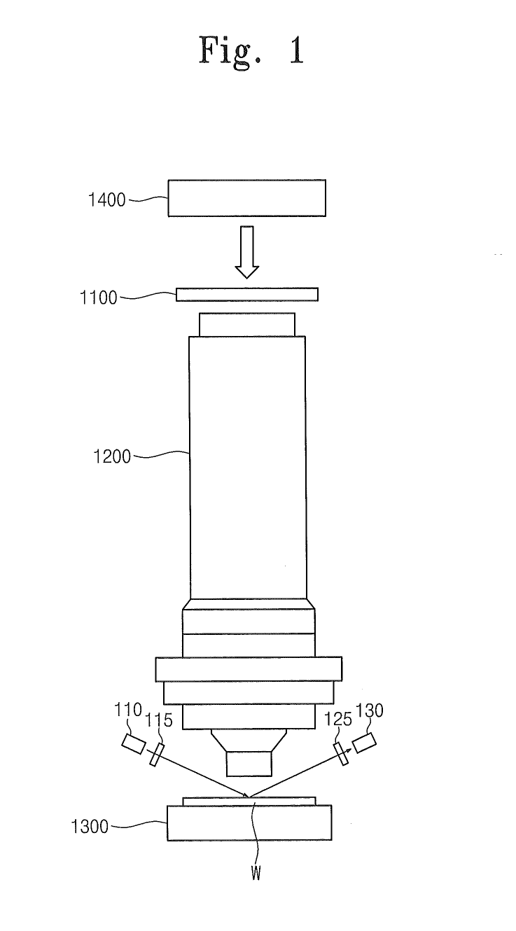

FIG. 1 is a schematic diagram of an exposure apparatus provided with a level sensor according to example embodiments of the inventive concept.

Referring to FIG. 1, an exposure apparatus may include a reticle 1100, an optical part for reduction projection 1200, a wafer stage 1300 and a light source 1400. The exposure apparatus may include at least one level sensor 110, 115, 125, and 130 for measuring level and tilt of a surface of a wafer W.

The reticle 1100 may be configured to include a user-designed pattern image to be transferred onto the wafer W through a photolithography process.

The optical part for reduction projection 1200 may be configured to align the pattern image of the reticle 1100 to patterns provided on the wafer W in a photolithography process.

The wafer stage 1300 may be configured to support the wafer W, on which the pattern image of the reticle 1100 will be transferred, during the photolithography process.

The light source 1400 may be configured to generate a light (depicted by a block arrow), which will be used to transfer the pattern image of the reticle 1100 onto the wafer W during the photolithography process.

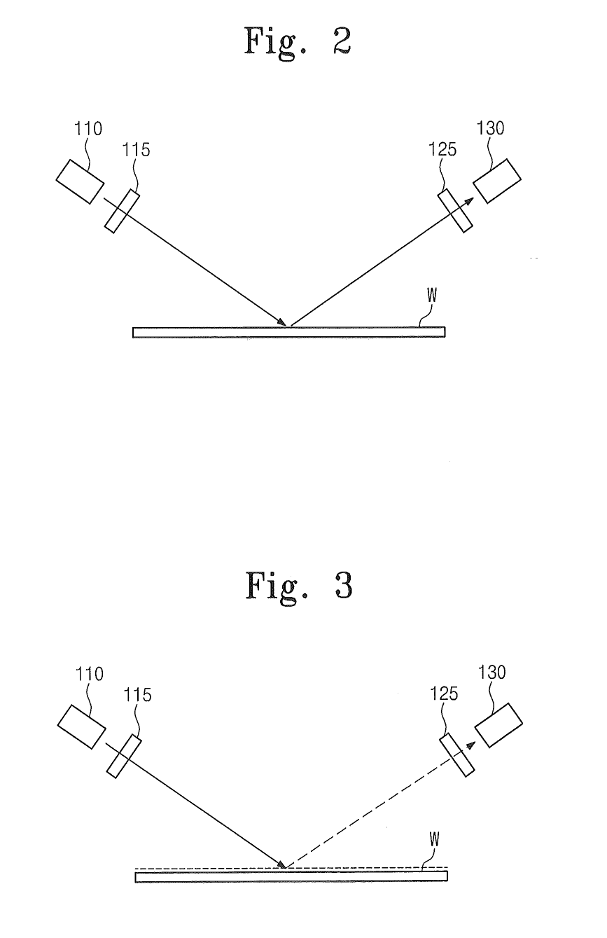

The level sensors 110, 115, 125, and 130 will be described in more detail with reference to FIGS. 2 through 5.

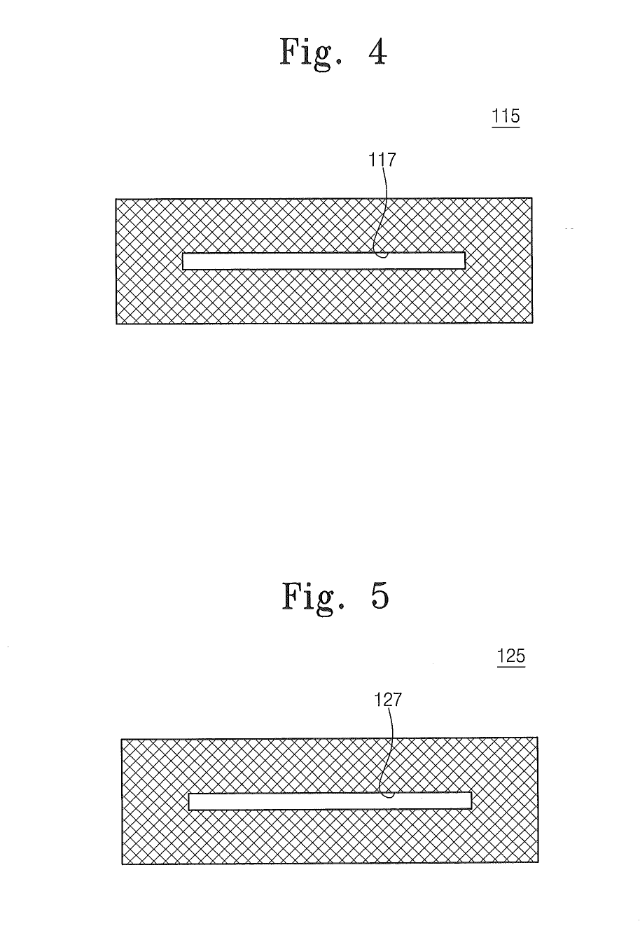

FIGS. 2 and 3 are schematic diagrams illustrating level sensors and wafer-leveling methods using the same, according to example embodiments of the inventive concept, and FIGS. 4 and 5 are plan views illustrating parts of a level sensor according to some embodiments of the inventive concept.

Referring to FIGS. 2 through 5, the level sensor of the exposure apparatus may include a light source 110, a projection part 115, a detection part 125, and a detector 130.

The light source 110 may generate a light to be illuminated onto a top surface of the wafer W. In example embodiments, the light source 110 may be a halogen lamp, but example embodiments of the inventive concept may not be limited thereto.

The projection part 115 may be configured to include a single projection slit 117, through which light generated by the light source 110 may pass, instead of a periodic grating. That is, a single slit may be used as opposed to a periodic array of slits. Light from the light source 110 may be incident to the top surface of the wafer W through the projection slit 117 of the projection part 115. The projection slit 117 may have a width of 4 mm or less and a length of 26 mm or more.

The detection part 125 may include a single detection slit 127, through which light reflected from the wafer W may pass. That is, the detection part may include a single slit rather than a periodic array of slits. Thus, the reflected light from the wafer W may be incident to the detector 130 through the detection slit 127 of the detection part 125. The detection slit 127 may have a width and a length that are equal to or greater than the width and the length of the projection slit 117, respectively.

The detector 130 may sense reflected light passing through the detection slit 127 of the detection part 125. The detector 130 may be an imaging device configured to sense the reflected light two-dimensionally. The imaging device may be a charge-coupled device (CCD) image sensor or a CMOS image sensor (CIS), but embodiments of the inventive concept may not be limited thereto. The detector 130 may sense a change in intensity of the reflected light.

A wafer leveling process, in which the level sensor may be used, may be performed using light that passes through the projection slit 117 of the projection part 115 and is incident on and then reflected from the top surface of the wafer W. The light reflected from the wafer W may pass through the detection slit 127 of the detection part 125 and be detected by the detector 130. In example embodiments, the detector 130 may be configured to detect a two-dimensional variation in intensity of the reflected light from the detection slit 127. In other words, a change in level of the top surface of the wafer W (depicted by a dotted line in FIG. 3) may result in a change in level of reflected light (depicted by a dotted arrow in FIG. 3) incident into the detector 130, and the change in level of the reflected light may result in a change in intensity of the reflected light.

Although FIG. 2 shows that a light from the projection part 115 is directly incident to the top surface of the wafer W, and then, is reflected from the wafer W to be directly incident to the detection part 125, example embodiments of the inventive concept may be modified in such a way that additional optical components may be provided on the propagating path of the light.

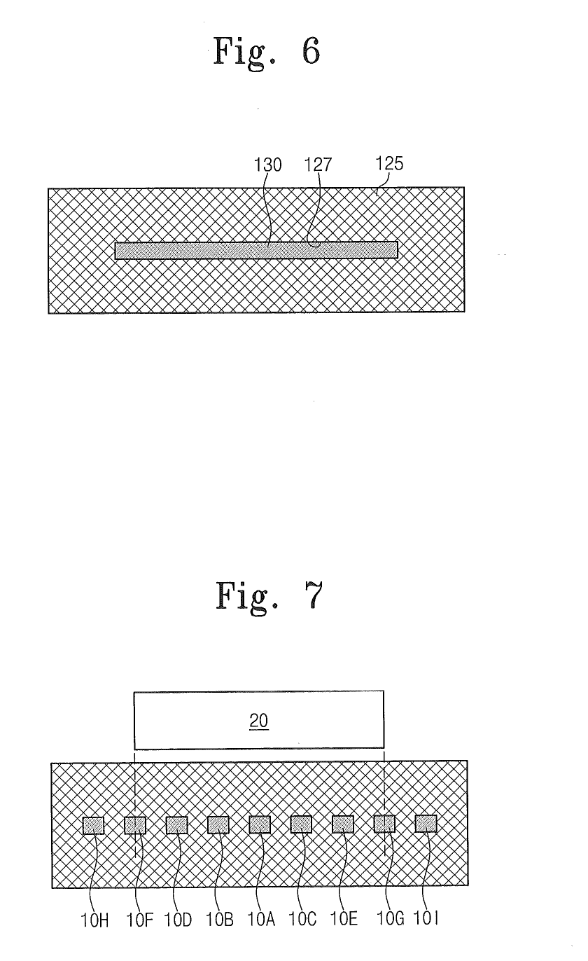

FIG. 6 is a plan view illustrating parts of a level sensor according to example embodiments of the inventive concept.

Referring to FIG. 6, the level sensor of the exposure apparatus may include the detection part 125 and the detector 130. The detector 130 may be in contact with a surface of the detection part 125 opposite to a surface, to which the reflected light is incident. In this case, the reflected light passing through the detection slit 127 of the detection part 125 may be almost incident to the detector 130 without loss. In other words, the detection part 125 and the detector 130 may be provided in the form of single component, and thus, level and tilt of the surface of the wafer can be measured with increased accuracy.

According to some embodiments of the inventive concepts, the level sensor of the exposure apparatus may include the projection part and the detection part, which may be provided in the form of a single slit, not a periodic grating, and the detector configured to detect the reflected light two-dimensionally. This configuration may enable more data to be obtained on each shot. Accordingly, it is possible to improve the spatial resolution of the level sensor of the exposure apparatus, without a non-measurable area. As a result, the level sensor of the exposure apparatus can measure level and tilt of the surface of the wafer with increased accuracy. Further, since the level sensor of the exposure apparatus can provide a high spatial resolution without a non-measurable area, there may be no necessity to perform an additional interpolation on the measured result.

Furthermore, in the level sensor of the exposure apparatus according to some embodiments of the inventive concept, illumination and detection of a light may be performed using the projection and detection parts provided in the form of a single slit and the detector configured to detect the reflected light two-dimensionally. This may enable more data to be obtained on each shot. Accordingly, it may be possible to improve the spatial resolution of the level sensor of the exposure apparatus, without a non-measurable area. As a result, it may be possible to provide a wafer leveling method capable of increasing accuracy in measuring level and tilt of the surface of the wafer. Further, since the level sensor of the exposure apparatus can provide a high spatial resolution without a non-measurable area, there is no necessity to perform an additional interpolation on the measured result.

While example embodiments of the inventive concepts have been particularly shown and described, it will be understood by one of ordinary skill in the art that variations in form and detail may be made therein without departing from the spirit and scope of the attached claims.

1. A level sensor of an exposure apparatus, comprising:
a light source that generates light that is illuminated onto a top surface of a wafer;
a projection part provided in a path of incident light propagating from the light source to the wafer, the projection part having a single first slit;
a detection part provided in a path of reflected light that is reflected from the wafer, the detection part having a single second slit; and
a detector that detects the reflected light that passes through the second slit of the detection part.

2. The level sensor of claim 1, wherein the detector comprises an imaging device configured to sense the reflected light two-dimensionally.

3. The level sensor of claim 2, wherein the imaging device comprises a charge-coupled device.

4. The level sensor of claim 1, wherein the detector is configured to sense a change in intensity of the reflected light.

5. The level sensor of claim 1, wherein the light source comprises a halogen lamp.

6. The level sensor of claim 1, wherein the first slit has a width of 4 mm or less and a length of 26 mm or more.

7. The level sensor of claim 1, wherein the second slit has a width and a length that are equal to or greater than a width and a length of the first slit, respectively.

8. The level sensor of claim 1, wherein the detector is in contact with a first surface of the detection part opposite to a second surface of the detection part onto which the reflected light is incident.

9.-14. (canceled)
